(19) United States
(12) Patent Application Publication
(10) Pub. No.: US 2025/0055579 A1
(43) Pub. Date: Feb. 13, 2025

(54) UE AUTONOMOUS RESOURCE SELECTION FOR STANDALONE SIDELINK CSI-RS

(71) Applicant: Nokia Technologies Oy, Espoo (FI)

(72) Inventors: Daniel MEDINA, Munich (DE); Prajwal KESHAVAMURTHY, Munich (DE); Ali KARIMIDEHKORDI, Munich (DE); Paolo BARACCA, Munich (DE); Diomidis MICHALOPOULOS, Munich (DE); Torsten WILDSCHEK, Gloucester (GB)

(21) Appl. No.: 18/795,739

(22) Filed: Aug. 6, 2024

(30) Foreign Application Priority Data
Aug. 10, 2023 (GB) 2312233.6

(51) Int. Cl. H04B 17/318; H04L 5/00

(52) U.S. Cl. CPC H04B 17/318; H04L 5/0048

(57) ABSTRACT

An apparatus configured to: determine a reserved resource for a first transmission and a received signal strength associated with the reserved resource; determine, from a set of candidate resources for a second transmission, a candidate resource, wherein the candidate resource at least partially overlaps in time with the reserved resource, wherein the candidate resource does not overlap in frequency with the reserved resource; determine a relative location, in frequency, of the candidate resource with respect to at least one of: the reserved resource, a first carrier frequency associated with the first transmission, or a second carrier frequency associated with the second transmission; and exclude the candidate resource from the set of candidate resources in response to the received signal strength, associated with the reserved resource, being above a resource exclusion threshold, wherein the resource exclusion threshold is based, at least partially, on the relative location of the candidate resource.

### TECHNICAL FIELD

The example and non-limiting embodiments relate generally to sidelink communication and, more particularly, to resource selection for transmission of sidelink reference signals.

### BACKGROUND

It is known, in physical sidelink control channel (PSCCH) and physical sidelink shared channel (PSSCH) resource selection, to exclude resources that overlap in time and frequency with reserved resources.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: determine a reserved resource for a first transmission and a received signal strength associated with the reserved resource; determine, from a set of candidate resources for a second transmission, at least one candidate resource, wherein the at least one candidate resource at least partially overlaps in time with the reserved resource, wherein the at least one candidate resource does not overlap in frequency with the reserved resource; determine a relative location, in frequency, of the at least one candidate resource with respect to at least one of: the reserved resource, a first carrier frequency associated with the first transmission, or a second carrier frequency associated with the second transmission; and exclude the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

In accordance with one aspect, a method comprising: determining, with a user equipment, a reserved resource for a first transmission and a received signal strength associated with the reserved resource; determining, from a set of candidate resources for a second transmission, at least one candidate resource, wherein the at least one candidate resource at least partially overlaps in time with the reserved resource, wherein the at least one candidate resource does not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

In accordance with one aspect, an apparatus comprising means for: determining a reserved resource for a first transmission and a received signal strength associated with the reserved resource; determining, from a set of candidate resources for a second transmission, at least one candidate resource, wherein the at least one candidate resource at least partially overlaps in time with the reserved resource, wherein the at least one candidate resource does not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

In accordance with one aspect, a non-transitory computer-readable medium comprising program instructions stored thereon for performing at least the following:

determining a reserved resource for a first transmission and a received signal strength associated with the reserved resource; determining, from a set of candidate resources for a second transmission, at least one candidate resource, wherein the at least one candidate resource at least partially overlaps in time with the reserved resource, wherein the at least one candidate resource does not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein; and

FIG. 4 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AMF access and mobility management function
CE control element
cRAN cloud radio access network
CSI-RS channel state information reference signal
CU central unit
D2D device to device
DMRS demodulation reference signal
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FR2 frequency range 2
gNB (or gNodeB) base station for 5G/NR, i.e., a node providing NR user plane and control plane protocol terminations towards the UE, and connected via the NG interface to the 5GC
IBE in-band emission
IE information element
I/F interface
IoT Internet of Things
I/Q or IQ In-phase and Quadrature components
IUC inter-UE coordination
L1 layer 1
LTE long term evolution
MAC medium access control
MME mobility management entity
ng or NG new generation
ng-eNB or NG-eNB new generation eNB
NR new radio
N/W or NW network
OFDM orthogonal frequency division multiplexing
O-RAN open radio access network
PDCP packet data convergence protocol
PHY physical layer
PRB physical resource block
ProSe proximity services
PSCCH physical sidelink control channel
PSFCH physical sidelink feedback channel
PSSCH physical sidelink shared channel
RAN radio access network
RE resource element
RF
radio frequency
radio link control
RLC
RRC radio resource control
RRH remote radio head
RS reference signal
RSRP reference signal received power
RS-SINR reference signal signal-to-interference-plus-noise ratio
RSW resource selection window
RU radio unit
Rx receiver
SCI sidelink control information
SDAP service data adaptation protocol
SDU service data unit
SGW serving gateway
SL sidelink
SL-PRS sidelink positioning reference signal
SMF session management function
Tx transmitter
UE user equipment (e.g., a wireless, typically mobile device)
UPF user plane function
V2I vehicle to infrastructure
V2N vehicle to network
V2P vehicle to pedestrian
V2V vehicle to vehicle
V2X vehicle to everything
VNF virtualized network function

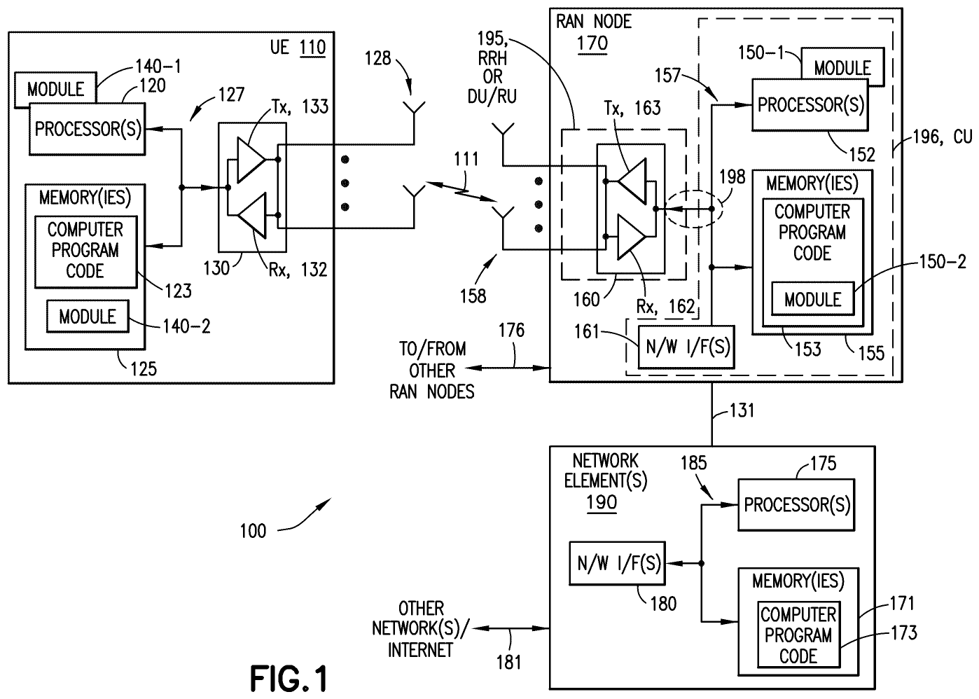

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber or optics other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants having (PDAs) wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to, while not being limited to, new radio (NR) sidelink (SL) enhancements. For example, NR SL methods may be implemented to provide communication between a vehicle and a network, infrastructure(s), other vehicle(s), or other road user(s) in the surrounding/immediate area. Such communication may enable proximity services (ProSe), or transmission of information about the surrounding environment, between devices in close proximity, for example device-to-device (D2D) communication technology. Such direct communication may be available even when network coverage is unavailable. Additionally or alternatively, NR SL methods may be implemented in scenarios unrelated to traffic users, such as public safety scenarios and/or commercial scenarios.

Additionally or alternatively, NR SL methods may relate to Internet of Things (IoT) and automotive industries (e.g., for reduction of accident risk and safer driving experiences). These use cases may include a message exchange among vehicles (V2V), vehicles and pedestrians (V2P), vehicles and infrastructure (V2I) and vehicles and networks (V2N), and may be referred to as vehicle-to-everything (V2X). Sidelink may use the same or different carrier frequencies or frequency bands than cellular communication.

Enhancements to sidelink procedures may be applicable in these V2X and other use cases. Enhancements to sidelink procedures may be applicable to unicast, groupcast, and/or broadcast procedures.

Features as described herein may generally relate to sidelink evolution, for example in the context of the 3GPP Rel-18 work item on NR sidelink evolution (NR_SL_enh2, RP-230077). Features as described herein may have the technical effect of addressing the objective related to sidelink operation in FR2 licensed spectrum.

Features as described herein may generally relate to resource allocation for standalone SL channel state information reference signals (CSI-RS).

Features as described herein may generally relate to UE Autonomous Resource Selection for PSCCH/PSSCH (also known as “Mode 2”). 3GPP TS 38.214, clause 8.1.4 specifies UE autonomous resource exclusion for PSCCH/PSSCH transmission based on sensing (i.e., SCI decoding and associated reference signal received power (RSRP) measurement). Step 6 of the standardized resource exclusion procedure (reproduced below) takes into account whether a candidate resource R_{x,y} (or a future instance thereof, in case of periodic resource reservation) overlaps (in both time and frequency) with a reserved resource (or a future instance thereof, in case of periodic resource reservation): “ . . . 6) The UE shall exclude any candidate single-slot resource R_{x, y} from the set S_{A} if it meets all the following conditions:
a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{RX}, respectively according to Clause 16.4 in [6, TS 38.213];
b) the RSRP measurement performed, according to clause 8.4.2.1 for the received SCI format 1-A, is higher than Th(prio_{RX}, prio_{TX});
c) the SCI format received in slot t′ₘ^{SL} or the same SCI format which, if and only if the ‘Resource reservation period’ field is present in the received SCI format 1-A, is assumed to be received in slot(s) t′_{m+q×P′}_{_{rsvp_RX}}^{SL} determines according to clause 8.1.5 the set of resource blocks and slots which overlaps with R_{x,y+j×P′}_{_{P′rsvp_TX}} for q=1, 2, . . . , Q and j=0, 1, . . . , Cᵣₑₛₑₗ−1. Here, P′_{rsvp_RX} is P_{rsvp_RX} converted to units of logical slots according to clause 8.1.7,

$$Q = ⌈ \frac{{T}_{scal}}{{P}_{rsvp\_RX}} ⌉$$

if P_{rsvp_RX}<T_{scal} and n′−m≤P′_{rsvp_RX}, where if the UE is configured with full sensing by its higher layer, t′_{n′}^{SL}=n if slot n belongs to the set (t′₀^{SL}, t′₁^{SL}, . . . , t′_{T′}_{_{max−1}}^{SL}), otherwise slot t′_{n′}^{SL} is the first slot after slot n belonging to the set (t′₀^{SL}, t′₁^{SL}, . . . , t′_{T′}_{_{max−1}}^{SL}); If UE is configured with partial sensing by its higher layer, t′_{n′}^{SL}=t′_{y}_{ᵢ}^{SL}−T_{proc,1}^{SL} if slot t′_{y}_{ᵢ}^{SL}−T_{proc,1}^{SL} belongs to the set (t′₀^{SL}, t′₁^{SL}, . . . , t′_{T′}_{_{max−1}}^{SL}), otherwise, slot [symbol] t′_{n′}^{SL} is the first slot after slot t′_{y}_{ᵢ}^{SL}−T_{proc,1}^{SL} belonging to the set (t′₀^{SL}, t′₁^{SL}, . . . , t′_{T′}_{_{max−1}}^{SL}). Otherwise Q=1. If the UE is configured with full sensing by its higher layer, T_{scal} is set to selection window size T₂ converted to units of msec. If UE is configured with partial sensing by its higher layer, T_{scal}=t′_{y}_{_{L}}^{SL}−(t′_{y}_{ᵢ}^{SL}−T_{proc,1}^{SL}) be converted to milliseconds, where slot t′_{y}_{_{L}}^{SL} is the last slot of the Y or Y′ candidate slots. The slot t′_{y}_{ᵢ}^{SL} is the first slot of the selected/remaining set of Y or Y′ candidate slots.”

Sensing-based resource exclusion (also known as “Mode 2”) has been standardized in Rel-16 NR SL, and related inter-UE coordination (IUC) enhancements were later introduced in Rel-17 (see 3GPP TS 38.214, clause 8.1.4). In step 6 of the UE autonomous resource exclusion procedure (which is used also for determining preferred resources for transmission by another UE in IUC scheme 1, according to clause 8.1.4A), candidate resources may be excluded if they overlap in both time and frequency with reserved resources. However, candidate resources that overlap with reserved resources in time but not in frequency are currently not excluded—except when the UE determines a preferred resource set for another UE's transmission, for which it is a destination UE, and it does not expect to perform SL reception in a slot due to half-duplex operation (step 6a).

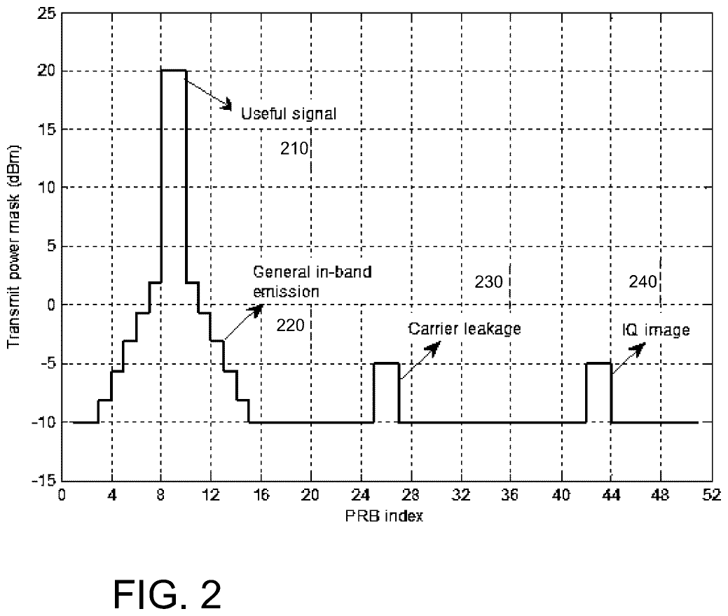

In reality, interference among simultaneous SL transmissions may occur even when there is no frequency overlap, for example due to so-called in-band emissions (IBE) caused by transmitter imperfections (e.g., adjacent channel leakage, I/Q image, carrier leakage, etc.), as shown in FIG. 2, and/or other factors (e.g., high mobility causing inter-carrier interference). This is particularly problematic in SL due to the near-far issue: an intended transmitter may be much further away from the intended receiver than an interferer, thus the desired signal may be much weaker than the interference signal.

Referring now to FIG. 2, illustrated is an example of a transmit power mask showing in-band emissions (IBE). The y-axis shows transmit power mask (dBm), while the x-axis shows physical resource block (PRB) index. Useful signal(s) are illustrated at 210. General in-band emission is illustrated at 220. Carrier leakage is illustrated at 230. IQ image is illustrated at 240.

Resource allocation for standalone SL CSI-RS in FR2 is currently being discussed in 3GPP (see above agreement), and Mode 2 is likely to be discussed as a starting point. However, standalone SL CSI-RS may be particularly prone to the above-described impairments, especially if comb-based multiplexing of standalone SL CSI-RS transmissions is supported by the resource allocation mechanism. Thus, enhancements may be necessary to address interference among time-overlapping standalone SL CSI-RSs that do not overlap in frequency.

Potentially, the current MAC layer behavior (3GPP TS 38.321) of uniformly random selection among the candidate resource set (SA) reported by the PHY layer may be modified. For example, a bias may be introduced in the random selection (MAC) such that candidate resources that are further away in frequency from time-overlapping reserved resources may be more likely to be selected. However, while this might improve link-level performance due to a reduced in-band emission (IBE) impact, system-level performance might deteriorate due to a higher likelihood of UEs selecting the same resources, leading to more frequent resource collisions, compared to uniformly random selection.

In an example embodiment, a UE may perform autonomous resource selection for standalone sidelink CSI-RS. In an example embodiment, the currently standardized NR sidelink resource exclusion procedure (UE autonomous resource selection for PSCCH/PSSCH, also known as Mode 2) specified in 3GPP TS 38.214 (clause 8.1.4) may be enhanced, for example by excluding candidate resources that overlap in time but not in frequency with reserved resource(s) based on a resource exclusion threshold that is a function of a relative location in frequency of the candidate resource with respect to the reserved resource(s) and/or associated carrier frequencies.

For example, if the transmit power mask of FIG. 2 corresponds to a reserved resource (PRBs 8-9), it may be desirable to exclude candidate resources that are adjacent in frequency to the reserved resource 210 (e.g., PRBs 4-7 and PRBs 10-13), or candidate resources overlapping with the carrier frequency 230 (e.g., PRBs 25-26) or with the I/Q image 240 (e.g., PRBs 42-43). However, to avoid over-exclusion of candidate resources, which may be detrimental to system-level performance, resource exclusion may depend on a received signal strength (e.g., RSRP) associated with the reserved resource. For example, if the RSRP is low, the impact of IBE may be negligible, whereas if the RSRP is high, the impact of IBE may be significant.

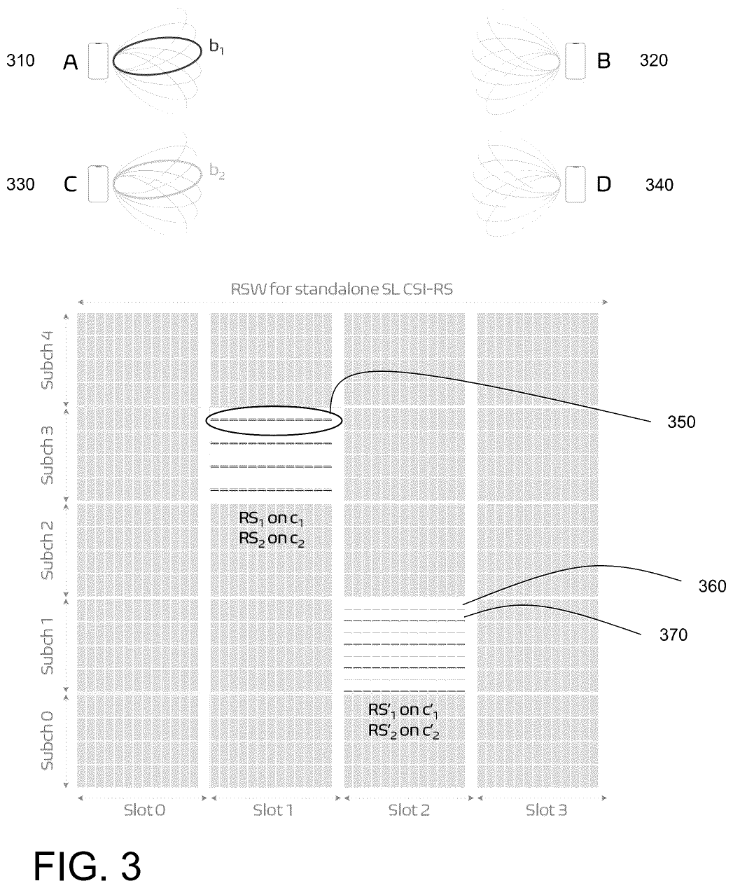

FIG. 3 shows two UE pairs (A (310), B (320)) and (C (330), D (340)) performing beam alignment (e.g., beam maintenance) based on standalone SL CSI-RS transmissions. UE A (310) and UE C (330) are examples of SL CSI-RS transmitter UEs that select adjacent (c₁, c₂) and/or non-adjacent (e.g., maximally separated) (c′₁, c′₂) transmission combs. A resource (e.g., slot, subchannel(s), transmission comb offset, etc.) for transmission of SL CSI-RS may be selected within a resource selection window (RSW) based on sensing (i.e., SCI decoding and RSRP measurement) and resource exclusion, similar to legacy PSCCH/PSSCH resource selection. In slot 1 and subchannel 3, UE A (310) and UE C (330) are shown to have selected adjacent transmission combs (C₁, c₂) for their SL CSI-RS transmissions (RS₁, RS₂). At 350, it may be noted that the dark dashed line indicating the standalone SL CSI-RS transmission on beam b₁ of UE A (310) and the light dashed line indicating the standalone SL CSI-RS transmission on beam b₂ of UE C (330) are close to each other. On the other hand, in slot 2 and subchannel 1, UE A (310) and UE C (330) are shown to have selected non-adjacent (in this case, maximally separated) transmission combs (c′₁, c′₂) for their SL CSI-RS transmissions (RS′₁, RS′₂). At 360, the light dashed line indicating the standalone SL CSI-RS transmission on beam b₂ of UE C (330) is separated from, at 370, the dark dashed line indicating the standalone SL CSI-RS transmission on beam b₁ of UE A (310). Depending on the specific interference geometry (e.g., physical distances among the UEs, etc.), the impact of selecting adjacent vs non-adjacent frequency resources for simultaneous standalone SL CSI-RS transmissions may vary.

In an example embodiment, a UE (e.g., SL RX UE, SL TX UE) may determine a reserved radio resource (r₁) for a first radio transmission (RS₁) and a received signal strength (RSRP) associated with the reserved radio resource (r₁). In an example embodiment, the UE may determine a candidate radio resource (r₂) for a second radio transmission (RS₂), wherein the candidate radio resource (r₂) may overlap in time and may not overlap in frequency with the reserved radio resource (r₁). In an example embodiment, the UE may determine a relative location in frequency of the candidate radio resource (r₂) with respect to at least one of: the reserved radio resource (r₁); a first carrier frequency (f₁) to be used for the first radio transmission (RS₁); or a second carrier frequency (f₂) to be used for the second radio transmission (RS₂). In an example embodiment, the UE may exclude the candidate radio resource (r₂) from a candidate resource set (S_{A}) for the second radio transmission (RS₂) if the received signal strength (RSRP) is above a resource exclusion threshold (Th), wherein the resource exclusion threshold (Th) may be a function of the relative location in frequency of the candidate radio resource (r₂).

In an example embodiment, the first and/or second radio transmission (RS₁, RS₂) may be a (CSI-) RS transmission.

In an example embodiment, the candidate resource set, after exclusion based on the resource exclusion threshold, may be used, for example, for transmission of SL positioning reference signals (SL-PRS), SL beam management reference signals (SL CSI-RS), etc. In other words, the second (radio) transmission may be transmitted via a candidate resource of the candidate resource set, after exclusion. A resource may be selected to transmit the second transmission, and/or a future instance of the second transmission, that may minimize the interference caused to the first transmission and/or a future instance of the first transmission. A resource may be selected to transmit the second transmission, and/or a future instance of the second transmission, that may minimize the interference resulting from the first transmission and/or a future instance of the first transmission.

In an example embodiment, the frequency-dependent resource exclusion threshold (Th) may be specified by means of a new RSRP threshold table, similar to the legacy non-frequency-dependent RSRP threshold table (sl-Thres-RSRP-List). For example, the new RSRP threshold table may include a new table dimension to capture the frequency dependence. Alternatively, a new frequency-dependent term may be added to the internal parameter Th (pᵢ, pⱼ) used in the legacy resource exclusion procedure.

A reserved resource (r₁) may be understood as comprising not only a resource indicated by a decoded SCI, but also a future instance thereof according to a resource reservation interval (P₁) associated with the reserved resource (r₁) (e.g., in case of periodic resource reservation for SL CSI-RS transmission).

Similarly, a candidate resource (r₂) may be understood as comprising not only a candidate resource within a resource selection window (RSW), but also a future instance thereof according to a resource reservation interval (P₂) associated with the candidate resource (r₂) (e.g., in case of periodic resource reservation for SL CSI-RS transmission).

In an example embodiment, the UE may be able to determine a first carrier frequency (f₁) to be used for the first transmission (RS₁). For example, the first carrier frequency (f₁) may be indicated explicitly or may be fixed in the specification. If so, the UE may determine whether the candidate resource (r₂) overlaps in frequency with the first carrier frequency (f₁), in which case the second transmission (RS₂) may suffer interference from the first transmission (RS1) due to carrier leakage.

In an example embodiment, the UE may determine the resource exclusion threshold (Th) based on the overlap. For example, in case of no overlap, the threshold may be set to infinity (i.e., no exclusion), and in case of overlap, the threshold may be set to a predefined value.

In an example embodiment, if the first carrier frequency (f₁) is known, the UE may also determine a first image frequency (i₁) associated with the reserved resource (r₁). For example, referring to FIG. 2, if the reserved resource 210 (r₁) corresponds to PRBs 8-9, the first image frequency 240 (i₁) may correspond to PRBs 42-43. The UE may then determine whether the candidate resource (r₂) overlaps in frequency with the first image frequency (i₁), in which case the second transmission (RS₂) may suffer interference from the first transmission (RS₁) due to emissions in the I/Q image. The UE may determine the resource exclusion threshold (Th) based on the overlap. For example, in case of no overlap, the threshold may be set to infinity (i.e., no exclusion), and in case of overlap, the threshold may be set to a predefined value.

In an example embodiment, the UE may be able to determine a second carrier frequency (f₂) to be used for the second transmission (RS₂). For example, if the UE is the (SL CSI-RS) transmitter UE (A (310), C (330)), the second carrier frequency (f₂) may be known to the UE. If the UE is the (SL CSI-RS) receiver UE (B (320), D (340)), the second carrier frequency (f₂) may be indicated explicitly by the (SL CSI-RS) transmitter UE (A (310), C (330)). If so, the UE may determine whether the reserved resource (r₁) overlaps in frequency with the second carrier frequency (f₂), in which case the second transmission (RS₂) may cause interference to the first transmission (RS₁) due to carrier leakage. The UE may determine the resource exclusion threshold (Th) based on the overlap. For example, in case of no overlap, the threshold may be set to infinity (i.e., no exclusion), and in case of overlap, the threshold may be set to a predefined value.

In an example embodiment, if the second carrier frequency (f₂) is known, the UE may also determine a second image frequency (i₂) associated with the candidate resource (r₂). For example, referring to FIG. 2, if the candidate resource 210 (r₂) corresponds to PRBs 8-9, the second image frequency 240 (1₂) may correspond to PRBs 42-43. The UE may then determine whether the reserved resource (r₁) overlaps in frequency with the second image frequency (1₂), in which case the second transmission (RS₂) may cause interference to the first transmission (RS₁) due to emissions in the I/Q image. The UE may determine the resource exclusion threshold (Th) based on the overlap. For example, in case of no overlap, the threshold may be set to infinity (i.e., no exclusion), and in case of overlap, the threshold may be set to a predefined value.

### Adjacency

In an example embodiment, the relative location in frequency may comprise a distance in frequency (e.g., number of subcarriers, number of PRBs, number of subchannels, etc.) between the candidate radio resource (r₂) and the reserved radio resource (r₁).

In an example embodiment, the resource exclusion threshold (Th) may decrease (i.e., making resource exclusion more likely) as the distance in frequency between the candidate radio resource (r₂) and the reserved radio resource (r₁) decreases. For example, the resource exclusion threshold may be proportional to the distance in frequency.

In an example embodiment, the closer that the reserved resource and the candidate resource are to each other in terms of frequency, the more likely it may be to exclude the candidate resource from the candidate resource set.

### Carrier Leakage of RS₁

In an example embodiment, the UE may determine the first carrier frequency (f₁). Additionally, the UE may determine whether the candidate radio resource (r₂) overlaps in frequency with the first carrier frequency (f₁). Additionally, the UE may determine the resource exclusion threshold (Th) based on said overlap determination.

### I/Q Image of RS₁

In an example embodiment, the UE may determine a first image frequency (i₁) associated with the reserved radio resource (r₁) based on the determined first carrier frequency (f₁). Additionally, the UE may determine whether the candidate radio resource (r₂) overlaps in frequency with the first image frequency (i₁). Additionally, the UE may determine the resource exclusion threshold (Th) based on said overlap determination.

### Carrier Leakage of RS₂

In an example embodiment, the UE may determine the second carrier frequency (f₂). Additionally, the UE may determine whether the reserved radio resource (r₁) overlaps in the carrier frequency with second frequency (f₂). Additionally, the UE may determine the resource exclusion threshold (Th) based on said overlap determination.

### I/Q Image of RS₂

In an example embodiment, the UE may determine a second image frequency (i₂) associated with the candidate radio resource (r₂) based on the determined second carrier frequency (f₂). Additionally, the UE may determine whether the reserved radio resource (r₁) overlaps in frequency with the second image frequency (i₂). Additionally, the UE may determine the resource exclusion threshold (Th) based on said overlap determination.

In an example embodiment, resource exclusion may be applied at a (SL CSI-RS) transmitter (TX) UE (A (310), C (330)) and/or a (SL CSI-RS) receiver (RX) UE (B (320), D (340)). In the latter case, the (SL CSI-RS) receiver UE (B (320), D (340)) may apply the enhanced resource exclusion when determining a preferred resource set for (SL CSI-RS) transmission by the (SL CSI-RS) transmitter UE (A (310), C (330)) (i.e., according to standard IUC scheme 1, specified in clause 8.1.4A of 3GPP TS 38.214). In general, a reserved resource (r₁) may be determined based on decoded SCI, as specified in 3GPP TS 38.214, clause 8.1.4.

### RS₂ RX UE

In an example embodiment, the received signal strength (e.g., RSRP) associated with the reserved resource (r₁) may be determined by measuring on at least one signal (e.g., PSCCH/PSSCH DMRS, CSI-RS, etc.) transmitted by a source UE of the first transmission (RS1). If the measurement is performed by the intended (SL CSI-RS) receiver UE (B (320), D (340)) of the second transmission (RS₂), then the measurement may be performed using a beam to be used for receiving the second transmission (RS₂). In this way, the actual receive beamforming gain at the intended (SL CSI-RS) receiver UE (B (320), D (340)) (i.e., the potential victim UE) may be taken into account.

### RS₂ TX UE

In an example embodiment, the received signal strength (e.g., RSRP) associated with the reserved resource (r₁) may be determined by measuring on at least one signal (e.g., PSCCH/PSSCH DMRS, PSFCH, etc.) transmitted by at least one destination UE of the first transmission (RS₁). If the measurement is performed by the (SL CSI-RS) transmitter UE (A (310), C (330)) of the second transmission (RS₂), then the measurement may be performed using a beam to be used for transmitting the second transmission (RS₂). In this way, assuming TX/RX beam correspondence, the actual transmit beamforming gain at the (SL CSI-RS) transmitter UE (A (310), C (330)) (i.e., the potential aggressor UE) may be taken into account.

### Priority

Priority may be used for collision avoidance in sidelink operation. For example, some TX UEs and/or transmissions may be higher priority than others. If a transmission is high priority, it may be less likely that a candidate resource is excluded for that transmission. In an example embodiment, if the priority of one transmission is very different from the priority of another transmission, the resource exclusion threshold may be lower than if the priority of one transmission is similar to the priority of another transmission.

In an example embodiment, the resource exclusion threshold (Th) may be further dependent on a first priority (p₁) associated with the first radio transmission (RS₁) and/or a second priority (p₂) associated with the second radio transmission (RS₂). The resource exclusion threshold (Th) may decrease as a difference between the first priority (p₁) and the second priority (p₂) increases. For example, the resource exclusion threshold may be inversely proportional to the difference in priority.

In an example embodiment, the resource exclusion threshold (Th) may further depend on the (SL CSI-RS) transmission priorities. For example, given a first priority (p₁) associated with the first transmission (RS₁) and a second priority (p₂) associated with the second transmission (RS₂), the resource exclusion threshold (Th) may be set to a lower value (thus making resource exclusion more likely) when the first priority (p₁) and the second priority (p₂) are further apart (e.g., top priority vs lowest priority).

### Relaxation

The candidate resource set includes a finite number of resources. If too many resources are being excluded from the candidate resource set based on the resource exclusion threshold, it may be necessary to relax the resource exclusion threshold such that fewer resources are excluded (i.e., by increasing the resource exclusion threshold).

In an example embodiment, the resource exclusion threshold (Th) may be increased by a predefined step (Δ) if a ratio of remaining candidate radio resources after resource exclusion is smaller than a configured minimum ratio (X). The predefined step (Δ) may be a function of a number of times the resource exclusion threshold (Th) has been increased.

In an example embodiment, the frequency-dependent resource exclusion threshold (Th) may be increased by a predefined step (Δ) if a ratio of remaining candidate resources (after resource exclusion) is smaller than a configured minimum ratio (X). In some embodiments, the predefined step (Δ) may be a function of a number of times the resource exclusion threshold (Th) has been increased. For example, an initial step Δ=3 dB may be used, which is then increased to Δ=6 dB after the initial step is applied, and so on. In this way, the impact of IBE may be considered to a lesser extent in a congested radio channel or resource pool.

### RS₂ Receiver

In an example embodiment, the RS₂ receiver may measure a second received signal strength (e.g., RSRP) based on a signal (e.g., PSCCH/PSSCH DMRS, SL CSI-RS, etc.) received from the RS₂ transmitter and determine the resource exclusion threshold (Th) based on the second received signal strength.

In an example embodiment, the measurement of the second received signal strength (e.g., RSRP) may be performed using a beam to be used for receiving the second transmission (RS₂). In this way, the actual receive beamforming gain at the intended (SL CSI-RS) receiver UE (B (320), D (340)) may be taken into account.

In an example embodiment, the resource exclusion threshold may increase as the second received signal strength increases. For example, the resource exclusion threshold may be proportional to the second received signal strength. For example, if the second received signal strength is high, then the threshold may be high (i.e., making exclusion less likely), as the SINR may be acceptable, or within a predefined range.

A technical effect of example embodiments of the present disclosure may be to improve UE autonomous resource selection (also known as Mode 2) by providing protection against in-band emissions (IBE), which may be particularly problematic for standalone SL CSI-RSS (compared to PSCCH/PSSCH) in case of comb-based multiplexing. By introducing a frequency-dependent RSRP threshold, a technical effect of example embodiments of the present disclosure may be to exclude candidate resources for SL CSI-RS transmission from resource selection if transmission in those candidate resources would cause (or suffer) substantial interference due to IBE.

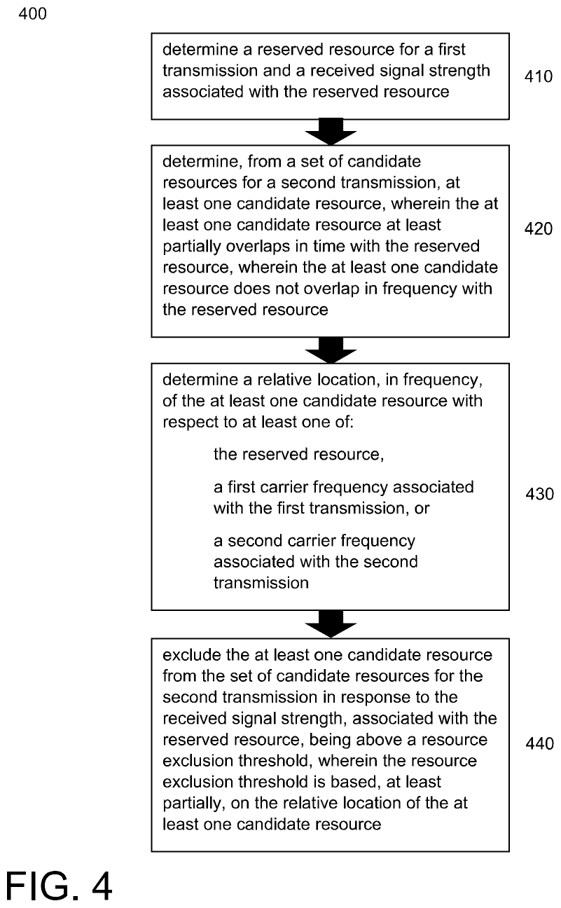

FIG. 4 illustrates the potential steps of an example method 400. The example method 400 may include: determining a reserved resource for a first transmission and a received signal strength associated with the reserved resource, 410; determining, from a set of candidate resources for a second transmission, at least one candidate resource, wherein the at least one candidate resource at least partially overlaps in time with the reserved resource, wherein the at least one candidate resource does not overlap in frequency with the reserved resource, 420; determining a relative location, in frequency, of the at least one candidate resource with respect to at least one of: the reserved resource, a first carrier frequency associated with the first transmission, or a second carrier frequency associated with the second transmission, 430; and excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource, 440. The example method 400 may be performed, for example, with a Tx SL UE or a Rx SL UE.

In accordance with one example embodiment, an apparatus may comprise: at least one processor; and at least one memory storing instructions that, when executed by the at least one processor, cause the apparatus at least to: determine a reserved resource for a first transmission and a received signal strength associated with the reserved resource; determine, from a set of candidate resources for a second transmission, at least one candidate resource, wherein the at least one candidate resource may at least partially overlaps in time with the reserved resource, wherein the at least one candidate resource may not overlap in frequency with the reserved resource; determine a relative location, in frequency, of the at least one candidate resource with respect to at least one of: the reserved resource, a first carrier frequency associated with the first transmission, or a second carrier frequency associated with the second transmission; and exclude the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

At least one of the first transmission or the second transmission may comprise one of: a reference signal transmission, or a channel state information reference signal transmission.

The relative location of the at least one candidate resource may comprise a distance, in frequency, between the at least one candidate resource and the reserved resource.

The resource exclusion threshold may decrease as the distance, in frequency, between the at least one candidate resource and the reserved resource decreases.

The example apparatus may be further configured to: determine the first carrier frequency associated with the first transmission; determine a first overlap, in frequency, between the at least one candidate resource and the first carrier frequency; and determine the resource exclusion threshold based, at least partially, on the first overlap.

The example apparatus may be further configured to: determine a first image frequency associated with the reserved resource based, at least partially, on the first carrier frequency associated with the first transmission; determine a second overlap, in frequency, between the at least one candidate resource and the first image frequency; and determine the resource exclusion threshold based, at least partially, on the second overlap.

The example apparatus may be further configured to: determine the second carrier frequency associated with the second transmission; determine a third overlap, in frequency, between the reserved resource and the second carrier frequency; and determine the resource exclusion threshold based, at least partially, on the third overlap.

The example apparatus may be further configured to: determine a second image frequency associated with the at least one candidate resource based, at least partially, on the second carrier frequency associated with the second transmission; determine a fourth overlap, in frequency, between the reserved resource and the second image frequency; and determine the resource exclusion threshold based, at least partially, on the fourth overlap.

Determining the received signal strength associated with the reserved resource for the first transmission may comprise the example apparatus being further configured to: measure the received signal strength on at least one signal received from a source user equipment, wherein the first transmission may comprise a transmission from the source user equipment.

The measurement may be performed using a beam to be used for receiving the second transmission.

Determining the received signal strength associated with the reserved resource for the first transmission may comprise the example apparatus being further configured to: measure the received signal strength on at least one signal received from at least one destination user equipment, wherein the first transmission may be directed towards the at least one destination user equipment.

The measurement may be performed using a beam to be used for transmitting the second transmission.

The example apparatus may be further configured to: determine a second received signal strength by measuring on at least one signal received from a source user equipment, wherein the second transmission may comprise a transmission from the source user equipment; and determine the resource exclusion threshold further based on the second received signal strength.

The measurement may be performed using a beam to be used for receiving the second transmission.

The resource exclusion threshold increases as the second received signal strength increases.

The resource exclusion threshold may be further based on at least one of: a priority of the first transmission, or a priority of the second transmission.

The resource exclusion threshold may decrease as a difference between the priority of the first transmission and the priority of the second transmission increases.

The example apparatus may be further configured to: determine a ratio between a number of candidate resources remaining in the set of candidate resources after excluding the at least one candidate resource and an initial number of candidate resources in the set of candidate resources; and increase the resource exclusion threshold in response to the determined ratio being less than a configured minimum ratio.

The resource exclusion threshold may be increased by a predefined step.

The predefined step may be based, at least partially, on a number of times the resource exclusion threshold has been increased.

The reserved resource for the first transmission may comprise one of: a resource indicated with sidelink control information, or a future instance of the reserved resource based, at least partially, on a resource reservation interval associated with the reserved resource.

The at least one candidate resource for the second transmission may comprise one of: a resource within a resource selection window, or a future instance of the at least one candidate resource based, at least partially, on a resource reservation interval associated with the at least one candidate resource.

In accordance with one aspect, an example method may be provided comprising: determining, with a user equipment, a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

At least one of the first transmission or the second transmission may comprise one of: a reference signal transmission, or a channel state information reference signal transmission.

The relative location of the at least one candidate resource may comprise a distance, in frequency, between the at least one candidate resource and the reserved resource.

The resource exclusion threshold may decrease as the distance, in frequency, between the at least one candidate resource and the reserved resource decreases.

The example method may further comprise: determining the first carrier frequency associated with the first transmission; determining a first overlap, in frequency, between the at least one candidate resource and the first carrier frequency; and determining the resource exclusion threshold based, at least partially, on the first overlap.

The example method may further comprise: determining a first image frequency associated with the reserved resource based, at least partially, on the first carrier frequency associated with the first transmission; determining a second overlap, in frequency, between the at least one candidate resource and the first image frequency; and determining the resource exclusion threshold based, at least partially, on the second overlap.

The example method may further comprise: determining the second carrier frequency associated with the second transmission; determining a third overlap, in frequency, between the reserved resource and the second carrier frequency; and determining the resource exclusion threshold based, at least partially, on the third overlap.

The example method may further comprise: determining a second image frequency associated with the at least one candidate resource based, at least partially, on the second carrier frequency associated with the second transmission; determining a fourth overlap, in frequency, between the reserved resource and the second image frequency; and determining the resource exclusion threshold based, at least partially, on the fourth overlap.

The determining of the received signal strength associated with the reserved resource for the first transmission may comprise: measuring the received signal strength on at least one signal received from a source user equipment, wherein the first transmission may comprise a transmission from the source user equipment.

The measurement may be performed using a beam to be used for receiving the second transmission.

The determining of the received signal strength associated with the reserved resource for the first transmission may comprise: measuring the received signal strength on at least one signal received from at least one destination user equipment, wherein the first transmission may be directed towards the at least one destination user equipment.

The measurement may be performed using a beam to be used for transmitting the second transmission.

The example method may further comprise: determining a second received signal strength by measuring on at least one signal received from a source user equipment, wherein the second transmission may comprise a transmission from the source user equipment; and determining the resource exclusion threshold further based on the second received signal strength.

The measurement may be performed using a beam to be used for receiving the second transmission.

The resource exclusion threshold may increase as the second received signal strength increases.

The resource exclusion threshold may be further based on at least one of: a priority of the first transmission, or a priority of the second transmission.

The resource exclusion threshold may decrease as a difference between the priority of the first transmission and the priority of the second transmission increases.

The example method may further comprise: determining a ratio between a number of candidate resources remaining in the set of candidate resources after excluding the at least one candidate resource and an initial number of candidate resources in the set of candidate resources; and increasing the resource exclusion threshold in response to the determined ratio being less than a configured minimum ratio.

The resource exclusion threshold may be increased by a predefined step.

The predefined step may be based, at least partially, on a number of times the resource exclusion threshold has been increased.

The reserved resource for the first transmission may comprise one of: a resource indicated with sidelink control information, or a future instance of the reserved resource based, at least partially, on a resource reservation interval associated with the reserved resource.

The at least one candidate resource for the second transmission may comprise one of: a resource within a resource selection window, or a future instance of the at least one candidate resource based, at least partially, on a resource reservation interval associated with the at least one candidate resource.

In accordance with one example embodiment, an apparatus may comprise: circuitry configured to perform: determining a reserved resource for a first transmission and a received signal strength associated with the reserved resource; circuitry configured to perform: determining, from a set of candidate resources for a second transmission, at least one candidate resource, wherein the at least one candidate resource may at least partially overlap in time with the reserved resource, wherein the at least one candidate resource may not overlap in frequency with the reserved resource; circuitry configured to perform: determining a relative location, in frequency, of the at least one candidate resource with respect to at least one of: the reserved resource, a first carrier frequency associated with the first transmission, or a second carrier frequency associated with the second transmission; and circuitry configured to perform: excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

In accordance with one example embodiment, an apparatus may comprise: processing circuitry; memory circuitry including computer program code, the memory circuitry and the computer program code configured to, with the processing circuitry, enable the apparatus to: determine a reserved resource for a first transmission and a received signal strength associated with the reserved resource; determine, from a set of candidate resources for a second transmission, at least one candidate resource, wherein the at least one candidate resource may at least partially overlaps in time with the reserved resource, wherein the at least one candidate resource may not overlap in frequency with the reserved resource; determine a relative location, in frequency, of the at least one candidate resource with respect to at least one of: the reserved resource, a first carrier frequency associated with the first transmission, or a second carrier frequency associated with the second transmission; and exclude the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware software (including signal processor(s) with digital processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: determining a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

At least one of the first transmission or the second transmission may comprise one a of: reference signal transmission, or a channel state information reference signal transmission.

The relative location of the at least one candidate resource may comprise a distance, in frequency, between the at least one candidate resource and the reserved resource.

The resource exclusion threshold may decrease as the distance, in frequency, between the at least one candidate resource and the reserved resource decreases.

The means may be further configured for: determining the first carrier frequency associated with the first transmission; determining a first overlap, in frequency, between the at least one candidate resource and the first carrier frequency; and determining the resource exclusion threshold based, at least partially, on the first overlap.

The means may be further configured for: determining a first image frequency associated with the reserved resource based, at least partially, on the first carrier frequency associated with the first transmission; determining a second overlap, in frequency, between the at least one candidate resource and the first image frequency; and determining the resource exclusion threshold based, at least partially, on the second overlap.

The means may be further configured for: determining the second carrier frequency associated with the second transmission; determining a third overlap, in frequency, between the reserved resource and the second carrier frequency; and determining the resource exclusion threshold based, at least partially, on the third overlap.

The means may be further configured for: determining a second image frequency associated with the at least one candidate resource based, at least partially, on the second carrier frequency associated with the second transmission; determining a fourth overlap, in frequency, between the reserved resource and the second image frequency; and determining the resource exclusion threshold based, at least partially, on the fourth overlap.

The means configured for determining the received signal strength associated with the reserved resource for the first transmission may comprise means configured for: measuring the received signal strength on at least one signal received from a source user equipment, wherein the first transmission may comprise a transmission from the source user equipment.

The measurement may be performed using a beam to be used for receiving the second transmission.

The means configured for determining the received signal strength associated with the reserved resource for the first transmission may comprise means configured for: measuring the received signal strength on at least one signal received from at least one destination user equipment, wherein the first transmission may be directed towards the at least one destination user equipment.

The measurement may be performed using a beam to be used for transmitting the second transmission.

The means may be further configured for: determining a second received signal strength by measuring on at least one signal received from a source user equipment, wherein the second transmission may comprise a transmission from the source user equipment; and determining the resource exclusion threshold further based on the second received signal strength.

The measurement may be performed using a beam to be used for receiving the second transmission.

The resource exclusion threshold may increase as the second received signal strength increases.

The resource exclusion threshold may be further based on at least one of: a priority of the first transmission, or a priority of the second transmission.

The resource exclusion threshold may decrease as a difference between the priority of the first transmission and the priority of the second transmission increases.

The means may be further configured for: determining a ratio between a number of candidate resources remaining in the set of candidate resources after excluding the at least one candidate resource and an initial number of candidate resources in the set of candidate resources; and increasing the resource exclusion threshold in response to the determined ratio being less than a configured minimum ratio.

The resource exclusion threshold may be increased by a predefined step.

The predefined step may be based, at least partially, on a number of times the resource exclusion threshold has been increased.

The reserved resource for the first transmission may comprise one of: a resource indicated with sidelink control information, or a future instance of the reserved resource based, at least partially, on a resource reservation interval associated with the reserved resource.

The at least one candidate resource for the second transmission may comprise one of: a resource within a resource selection window, or a future instance of the at least one candidate resource based, at least partially, on a resource reservation interval associated with the at least one candidate resource.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: determine a reserved resource for a first transmission and a received signal strength associated with the reserved resource; determine, from a set of candidate resources for a second transmission, at least one candidate resource, wherein the at least one candidate resource may at least partially overlap in time with the reserved resource, wherein the at least one candidate resource may not overlap in frequency with the reserved resource; determine a relative location, in frequency, of the at least one candidate resource with respect to at least one of: the reserved resource, a first carrier frequency associated with the first transmission, or a second carrier frequency associated with the second transmission; and exclude the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

In accordance with one example embodiment, a non-transitory computer-readable medium comprising program instructions stored thereon for performing at least the following: determining a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

In accordance with another example embodiment, a non-transitory program storage device readable by a machine may be provided, tangibly embodying instructions executable by the machine for performing operations, the operations comprising: determining a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

In accordance with another example embodiment, a non-transitory computer-readable medium comprising instructions that, when executed by an apparatus, cause the apparatus to perform at least the following: determining a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

A computer implemented system comprising: at least one processor and at least one non-transitory memory storing instructions that, when executed by the at least one processor, cause the system at least to perform: determining a reserved resource for a first transmission and a received signal strength associated with the reserved resource; determining, from a set of candidate resources for a second transmission, at least one candidate resource, wherein the at least one candidate resource may at least partially overlap in time with the reserved resource, wherein the at least one candidate resource may not overlap in frequency with the reserved resource; determining a relative location, in frequency, of the at least one candidate resource with respect to at least one of: the reserved resource, a first carrier frequency associated with the first transmission, or a second carrier frequency associated with the second transmission; and excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

A computer implemented system comprising: means for determining a reserved resource for a first transmission and a received signal strength associated with the reserved resource; means for determining, from a set of candidate resources for a second transmission, at least one candidate resource, wherein the at least one candidate resource may at least partially overlap in time with the reserved resource, wherein the at least one candidate resource may not overlap in frequency with the reserved resource; means for determining a relative location, in frequency, of the at least one candidate resource with respect to at least one of: the reserved resource, a first carrier frequency associated with the first transmission, or a second carrier frequency associated with the second transmission; and means for excluding the at least one candidate resource from the set of candidate resources for the second transmission in response to the received signal strength, associated with the reserved resource, being above a resource exclusion threshold, wherein the resource exclusion threshold may be based, at least partially, on the relative location of the at least one candidate resource.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-25. (canceled)

26. An apparatus comprising means for:
determining a reserved resource for a first transmission and a received signal strength associated with the reserved resource;
determining, from a set of candidate resources for a second transmission, at least one candidate resource, wherein the at least one candidate resource at least partially overlaps in time with the reserved resource, wherein the at least one candidate resource does not overlap in frequency with the reserved resource;
determining a relative location, in frequency, of the at least one candidate resource with respect to at least one of:
the reserved resource,
a first carrier frequency associated with the first transmission, or
a second carrier frequency associated with the second transmission; and
excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

27. The apparatus of claim 26, wherein at least one of the first transmission or the second transmission comprises one of:
a reference signal transmission, or
a channel state information reference signal transmission.

28. The apparatus of claim 26, wherein the relative location of the at least one candidate resource comprises a distance, in frequency, between the at least one candidate resource and the reserved resource.

29. The apparatus of claim 28, wherein the resource exclusion threshold decreases as the distance, in frequency, between the at least one candidate resource and the reserved resource decreases.

30. The apparatus of claim 26, wherein the means are further configured for:
determining the first carrier frequency associated with the first transmission;
determining a first overlap, in frequency, between the at least one candidate resource and the first carrier frequency; and
determining the resource exclusion threshold based, at least partially, on the first overlap.

31. The apparatus of claim 26, wherein means are further configured for:
determining a first image frequency associated with the reserved resource based, at least partially, on the first carrier frequency associated with the first transmission;
determining a second overlap, in frequency, between the at least one candidate resource and the first image frequency; and
determining the resource exclusion threshold based, at least partially, on the second overlap.

32. The apparatus of claim 26, wherein means are further configured for:
determining the second carrier frequency associated with the second transmission;
determining a third overlap, in frequency, between the reserved resource and the second carrier frequency; and
determining the resource exclusion threshold based, at least partially, on the third overlap.

33. The apparatus of claim 26, wherein the means are further configured for:
determining a second image frequency associated with the at least one candidate resource based, at least partially, on the second carrier frequency associated with the second transmission;
determining a fourth overlap, in frequency, between the reserved resource and the second image frequency; and
determining the resource exclusion threshold based, at least partially, on the fourth overlap.

34. The apparatus of claim 26, wherein the means configured for determining the received signal strength associated with the reserved resource for the first transmission comprises means configured for:
measuring the received signal strength on at least one signal received from a source user equipment, wherein the first transmission comprises a transmission from the source user equipment.

35. The apparatus of claim 34, wherein the measurement is performed using a beam to be used for receiving the second transmission.

36. The apparatus of claim 26, wherein the means configured for determining the received signal strength associated with the reserved resource for the first transmission comprises means configured for:
measuring the received signal strength on at least one signal received from at least one destination user equipment, wherein the first transmission is directed towards the at least one destination user equipment.

37. The apparatus of claim 36, wherein the measurement is performed using a beam to be used for transmitting the second transmission.

38. The apparatus of claim 26, wherein the means are further configured for:
determining a second received signal strength by measuring on at least one signal received from a source user equipment, wherein the second transmission comprises a transmission from the source user equipment; and
determining the resource exclusion threshold further based on the second received signal strength.

39. The apparatus of claim 38, wherein the measurement is performed using a beam to be used for receiving the second transmission.

40. The apparatus of claim 38, wherein the resource exclusion threshold increases as the second received signal strength increases.

41. The apparatus of claim 26, wherein the resource exclusion threshold is further based on at least one of:
a priority of the first transmission, or
a priority of the second transmission.

42. The apparatus of claim 41, wherein the resource exclusion threshold decreases as a difference between the priority of the first transmission and the priority of the second transmission increases.

43. apparatus of claim 26, wherein the means are further configured for:
determining a ratio between a number of candidate resources remaining in the set of candidate resources after excluding the at least one candidate resource and an initial number of candidate resources in the set of candidate resources; and
increasing the resource exclusion threshold in response to the determined ratio being less than a configured minimum ratio.

44. A method comprising:
determining, with a user equipment, a reserved resource for a first transmission and a received signal strength associated with the reserved resource;
determining, from a set of candidate resources for a second transmission, at least one candidate resource, wherein the at least one candidate resource at least partially overlaps in time with the reserved resource, wherein the at least one candidate resource does not overlap in frequency with the reserved resource;
determining a relative location, in frequency, of the at least one candidate resource with respect to at least one of:
the reserved resource,
a first carrier frequency associated with the first transmission, or
a second carrier frequency associated with the second transmission; and
excluding the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.

45. An apparatus comprising:
at least one processor; and
at least one non-transitory memory storing instructions that, when executed by the at least one processor, cause the apparatus at least to:
determine a reserved resource for a first transmission and a received signal strength associated with the reserved resource;
determine, from a set of candidate resources for a second transmission, at least one candidate resource, wherein the at least one candidate resource at least partially overlaps in time with the reserved resource, wherein the at least one candidate resource does not overlap in frequency with the reserved resource;
determine a relative location, in frequency, of the at least one candidate resource with respect to at least one of:
the reserved resource,
a first carrier frequency associated with the first transmission, or
a second carrier frequency associated with the second transmission; and
exclude the at least one candidate resource from the set of candidate resources for the second transmission in response to the received signal strength, associated with the reserved resource, being above a resource exclusion threshold, wherein the resource exclusion threshold is based, at least partially, on the relative location of the at least one candidate resource.
